(19) United States
(12) Patent Application Publication
(10) Pub. No.: US 2006/0048621 A1
(43) Pub. Date: Mar. 9, 2006

(54) Rotary cutter and rotary cutting apparatus provided with the rotary cutter

(75) Inventors: Gilbert Grenier, Annonay (FR); Lillian Monteil, Saint Martin D'Aout (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: SANDVIK INTELLECTUAL PROPERTY HB, Sandviken (SE)

(21) Appl. No.: 11/165,489

(22) Filed: Jun. 24, 2005

(30) Foreign Application Priority Data
Jul. 2, 2004 (SE) 0401734-9

(51) Int. Cl. B26D 7/20

(52) U.S. Cl. 83/659

(57) ABSTRACT

A rotary cutter for a rotary cutting apparatus. The rotary cutter includes a shaft and a mantle having at least one cutting member. The shaft is non-rotatable, and the mantle is rotatably mounted to the shaft and can be removed therefrom in an axial direction. The shaft is adapted to be rigidly mounted in a frame part, wherein the mantle is rotatably arranged relative to the shaft. The shaft may be in the form of a single piece, or a pair of axially spaced shaft portions.

The present application claims priority under 35 U.S.C. § 119 to patent application Ser. No. 0401734-9 filed in Sweden on Jul. 2, 2004.

### TECHNICAL BACKGROUND OF THE INVENTION

The present invention relates to a rotary cutter for a rotary cutting apparatus, comprising a shaft and a mantle, the mantle having at least one cutting member.

The invention also relates to a rotary cutting apparatus comprising a frame part, an anvil and such a rotary cutter.

U.S. Pat. No. 4,770,078 discloses in a discussion of the prior art (FIGS. 1-3) a one piece rotary cutter, which has to be removed from the frame when maintenance is needed. In order to allow the machine to be used during maintenance, a further rotary cutter including its static (stationary) shaft must always be accessible.

In order to overcome that problem, U.S. Pat. No. 4,770,078 suggests to divide the rotary cutter into a rotatable shaft and a mantle. The mantle is connected to the rotatable shaft by means of pneumatic pressure. A drawback with this kind of rotary cutter is that it is difficult to index the rotary cutter relative to the anvil. Another drawback is the lack of support of the rotary cutter on the axial side thereof opposite to the driven side.

### SUMMARY OF THE INVENTION

An object of the invention is to improve the adjustment possibilities of the rotary cutter. It is a further object to allow maintenance to be performed at a reduced cost and to be able to dismantle the rotary cutter in a simplified manner.

This has been achieved by a rotary cutter and a rotary cutting apparatus of the initially defined kind, wherein the shaft is adapted to be rigidly mounted in a frame part, and wherein the mantle is rotatably arranged relative to the shaft and removable therefrom. Hereby, indexing of the mantle relative to the shaft is made easier, since the mantle can be rotated relative to the static shaft. Furthermore, it is only necessary to perform maintenance of the mantle, i.e. the existing shaft can be used together with another mantle such that the production can be continued while maintenance is performed on the worn mantle.

Preferably, the mantle is adapted to be connected to a power source for creating a rotational movement of the mantle.

Preferably bearings are provided between the mantle and the shaft. Hereby, a controlled positional and relative rotational relationship between the static shaft and the mantle is achieved.

Suitably, a power transmission means is provided for transmitting the rotational movement to said mantle.

Advantageously, the mantle has an axial extension and opposite axial ends, wherein said mantle is adapted to be supported by the shaft and connected to the power source in the region of one of the ends of said mantle, and wherein said mantle is adapted to be supported by the shaft in the region of the opposite end.

Alternatively, said shaft is divided into first and second shaft portions, the mantle having an axial extension and opposite axial ends, wherein said mantle is adapted to be supported by the first shaft portion and connected to the power source in the region of one of the ends of said mantle, and wherein said mantle is adapted to be supported by the second shaft portion in the region of the opposite end.

Advantageously, the frame part of the rotary cutting apparatus further comprises a fastening means for said shaft and a power transmission connection means for said mantle.

### BRIEF DESCRIPTION OF THE DRAWINGS

In the following, preferred embodiments of the invention will be described in greater detail by reference to the accompanying drawings, in which

FIG. 1 illustrates a rotary cutting apparatus comprising an anvil and a rotary cutter according to a first embodiment of the invention, shown in longitudinal section;

FIG. 2 is a longitudinal sectional view of a second embodiment of the rotary cutter; and

FIG. 3 is a longitudinal sectional view of a third embodiment of the rotary cutter.

### DETAILED DESCRIPTION OF PREFERRED EMBODIMENTS

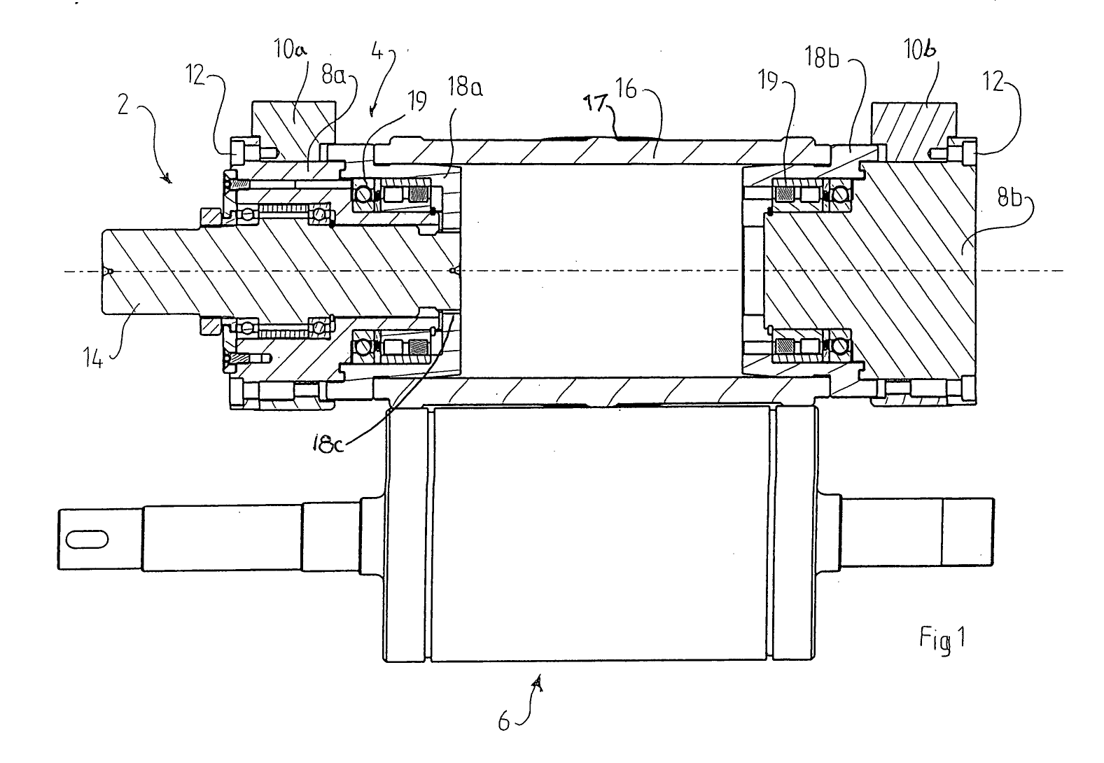

FIG. 1 shows a rotary cutting apparatus 2, comprising a rotary cutter 4 and an anvil roll 6. The rotary cutter 4 comprises a divided static (non-rotary) shaft 8, comprising shaft portions or members 8a, 8b, each shaft member being rigidly connected to a respective frame part 10a, 10b by means of screws 12. A drive axle 14 associated with a not-shown power source extends through the shaft member 8a for transmitting a rotational movement to a tool in the form of a mantle 16 via an intermediate transmission member 18a which is rotatably mounted on an outer periphery of the shaft member 8a The rotary motion is transmitted from the axle 14 to the member 18a via teeth 18c. The rotational movement is further transmitted to a rotational support 18b. Cylindrical bearings 19 are provided between the shaft members 8a, 8b and the intermediate transmission members 18a, 18b, respectively, for centering the mantle 16 relative to the shaft members 8a, 8b. The frame parts 10a, 10b are secured to the rest of a stationary frame by means of suitable, not-shown fastening means. The mantle 16 is provided with at least one cutting member 17.

During disassembly, the frame parts 10a, 10b are unsecured from the not-shown rest of the frame such that the static shaft members 8a, 8b, plus the transmission members 18a, 18b, can be pulled axially out from the mantle 16. The mantle 16 is taken away and maintenance can thus be performed. Another mantle 16 is mounted in place of the removed one, and the rotary cutting device can be utilised without long stoppage.

Of course, it may be enough to remove only one (either) of the static shaft members 8a and 8b, respectively, rather than both.

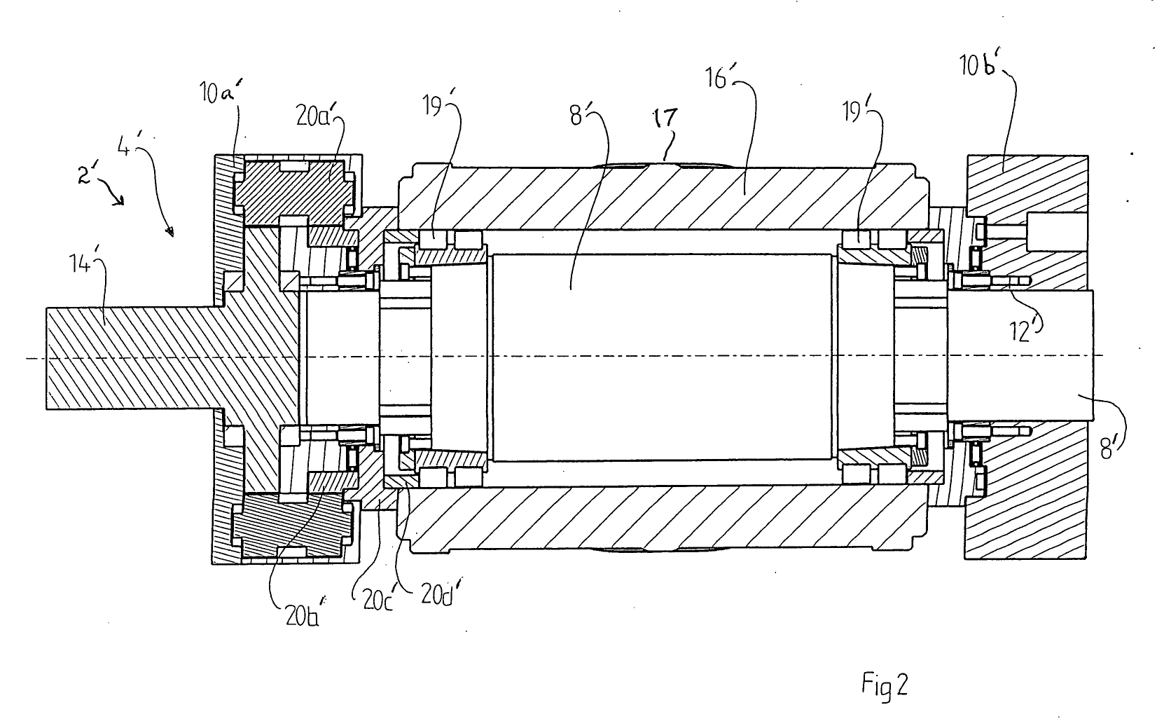

FIG. 2 shows a second embodiment of a rotary cutting apparatus 2′ and a rotary cutter 4′. The static shaft 8′ in this case comprises a single part and is connected to the frame parts 10a′, 10b′ on either side of the mantle 16′ by screws 12′. The rotational movement of the drive axle 14′ is transmitted to the mantle 16′ transmission mechanism which includes gears 20a′, 20b′, 20c′, 20d′. It should be noted that the parts 20b′, 20c′, 20d′ could be produced as two pieces or even one single piece. Centering is performed by means of cylindrical bearings 19′.

During disassembly, the frame part 10b′ in the right part of FIG. 2 is unsecured from the rest of the frame (i.e. the left frame part remains secured). The mantle 16′ can then be pulled axially away from the tool holder 8′.

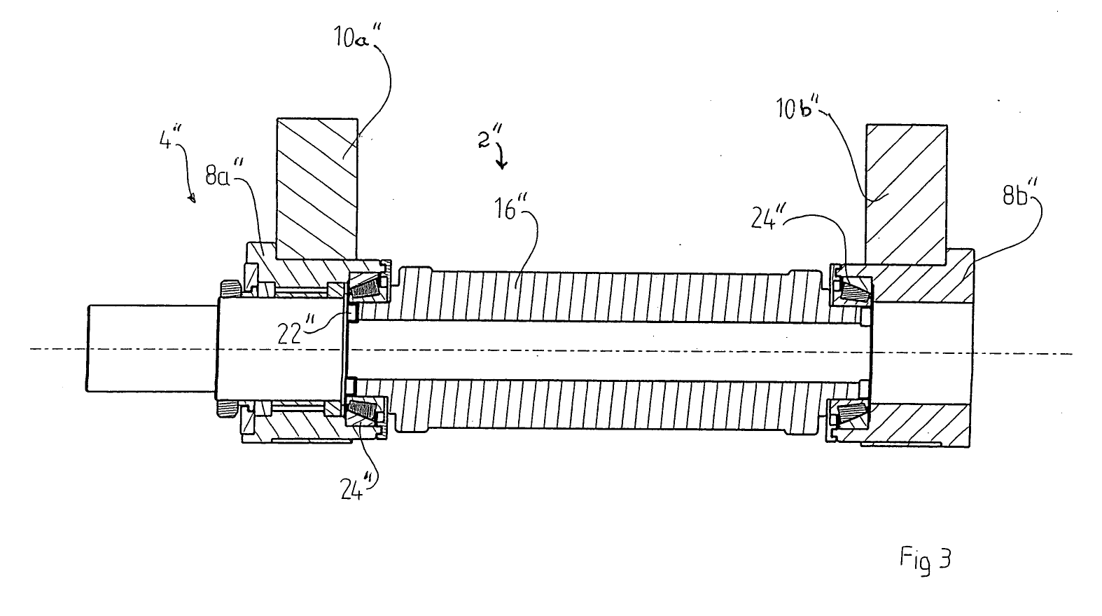

FIG. 3 shows a third embodiment of a rotary cutting apparatus 2″ and a rotary cutter 4″. In this case, the cross-section is such that the cutting member has been omitted. The drive axle 14″ transmits rotational movement directly to the mantle 16″ via a coupling member 22″ which is received in a recess of the mantle. The static shaft 8″ is divided into two shaft members or portions 8a″, 8b″ connected to the respective frame parts 10a″, 10b″ on either side of the mantle 16″. The mantle 16″ is centered relative to the shaft members 8a″, 8b″ and the driving axle 14″ by means of conical bearings 24″.

For maintenance purposes, the shaft member 8b″ is unsecured from the frame parts 10a″, 10b″, and then the mantle 16″ is released axially from the shaft member 8a″.

The mantle 16, 16′, 16″ may be made of a multiphase material, such as steel, cemented carbide or cermet (hard phase bonded by a metal).

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. A rotary cutter for a rotary cutting apparatus, the rotary cutter comprising a shaft and a mantle mounted to the shaft, the mantle carrying at least one cutting member, the shaft adapted to be rigidly mounted in a frame part, and the mantle being rotatable relative to the shaft and removable therefrom.

2. The rotary cutter according to claim 1 wherein the mantle is adapted for connection to a rotary drive source.

3. The rotary cutter according to claim 2 further including bearings disposed between the mantle and the shaft.

4. The rotary cutter according to claim 3 further including a power transmission mechanism for transmitting rotation to the mantle.

5. The rotary cutter according to claim 3 wherein only one end of the mantle is adapted for connection to a rotary drive source.

6. The rotary cutter according to claim 3 wherein the shaft comprises first and second axial shaft portions spaced apart along an axis of rotation of the mantle.

7. The rotary cutter according to claim 1 further including bearings disposed between the mantle and the shaft.

8. The rotary cutter according to claim 1 further including a power transmission mechanism supported by the shaft for transmitting rotary movement to the mantle.

9. The rotary cutter according to claim 1 wherein the shaft comprises first and second shaft portions spaced apart along an axis of rotation of the mantle.

10. A rotary cutting apparatus comprising:
a housing;
a shaft removably connected to the housing and being non-rotatable relative to the housing;
a mantle carrying at least one cutter element and mounted to the housing by bearings enabling the mantle to rotate relative to the shaft about a longitudinal axis of the shaft, the mantle being removable from the shaft in an axial direction; and
a rotary drive mechanism connected to the mantle for rotating the mantle.

11. The rotary cutting apparatus according to claim 10 wherein the rotary drive mechanism is rotatably supported by the shaft.

12. The rotary cutting apparatus wherein a part of the rotary drive mechanism extends coaxially through one end of the shaft and is rotatable relative thereto.

13. The rotary cutting apparatus according to claim 12 wherein another part of the rotary drive transmission is rotatably mounted on an outer periphery of the shaft.

14. The rotary cutting apparatus according to claim 10 wherein the shaft comprises shaft portions spaced apart along the axis.

15. The rotary cutting apparatus according to claim 10 further including an anvil mounted opposite the mantle and engageable with the at least one cutting member.

16. A rotary cutting apparatus comprising:
a housing;
a shaft removably connected to the housing by fastener structure and being non-rotatable relative thereto;
a rotary cutter rotatably mounted on the shaft for rotation relative thereto about a central longitudinal axis of the shaft, the rotary cutter being removable axially from the shaft; and
an anvil mounted opposite the rotary cutter for engagement therewith.

17. The rotary cutting apparatus according to claim 16 wherein the shaft comprises shaft portions spaced apart along the axis.

18. The rotary cutting apparatus according to claim 16 wherein a part of the rotary drive mechanism extends axially through one end of the shaft and is rotatable relative thereto.

19. The rotary cutting apparatus according to claim 18 wherein another part of the rotary drive transmission is rotatably mounted on an outer periphery of the shaft.
